(19) United States
(12) Patent Application Publication
(10) Pub. No.: US 2022/0180371 A1
(43) Pub. Date: Jun. 9, 2022

(54) Managing Conversations for Service Delivery Networks

(71) Applicant: M3G Technology, Inc., San Francisco, CA (US)

(72) Inventors: Douglas E. Marinaro, Santa Clara, CA (US); Aviraj B. Singh, Brooklyn, NY (US); Patrick John Banta, San Rafael, CA (US)

(21) Appl. No.: 17/540,149

(22) Filed: Dec. 1, 2021

Related U.S. Application Data
(60) Provisional application No. 63/122,837, filed on Dec. 8, 2020.

(51) Int. Cl. G06Q 30/00; H04W 4/12

(52) U.S. Cl. CPC G06Q 30/016; H04W 4/12

(57) ABSTRACT

Systems and methods for managing communications between customers and service providers within a service delivery network (SDN) are provided. An example method commences with receiving an event from an operator associated with an SDN. The event indicates that a request for a service has been received, by the operator, from a customer and assigned, by the operator, to one or more service providers associated with the SDN. The method includes ascertaining, based on the event, metadata associated with at least one of the customer, the operator, the one or more service providers, the request, and the service. The method continues with establishing, based on the metadata, a channel of communications between the customer and the one or more service providers.

### CROSS REFERENCE TO RELATED APPLICATIONS

The present application claims priority of U.S. Provisional Patent Application No. 63/122,837 filed on Dec. 8, 2020, entitled “Systems and Methods for Managing Conversations for Service Delivery Networks,” which is incorporated herein by reference in its entirety for all purposes.

### TECHNICAL FIELD

The present technology generally relates to data communications and, more specifically, to managing communications between a customer and service providers within a service delivery network.

### BACKGROUND

Product and service providers often rely on conversations with their customers before, during, and after the product or service delivery to ensure the products or services they are providing are delivered correctly and to the customer's satisfaction. These conversations, once held in person, shifted online as e-commerce dominated both business-to-consumer and business-to-business transactions and, more recently, to instant messaging as customers become accustomed to the responsiveness of on-demand services. These trends have accelerated dramatically in the recent times due to pandemic, changes in work environment, and changes in consumer behavior. Customers expect to be able to engage their service provider through an instant messaging channel at any time.

A Service Delivery Network (SDN) is two or more organizations that, in the eyes of a customer, are responsible for the provision of a connected overall service experience (Tax, S et al. “The Service Delivery Network (SDN) A Customer-Centric Perspective of the Customer Journey”, October 2013, J. Ser. Res. 16(4):454-470). Many small, independent businesses are part of larger networks anchored by a brand enterprise. The small business is a product or service provider that is often responsible for product or service delivery and has a significant impact on customer satisfaction. The brand enterprise and its provider networks are often challenged to work together to create a seamless, delightful experience for their end customers. When two or more organizations are responsible for the delivery of the service to an individual or business, breakdowns in communication can occur that may result in delays or improper delivery of the service leading to customer dissatisfaction and additional costs.

One example of an SDN occurs when one organization is a business with an established brand (also referred to herein a “brand enterprise,” or a “brand”) who contractually aggregates the services of many local businesses or other businesses (also referred to herein the “providers”) to provide services to one or more customers (the “customers”) on behalf of the brand. Customers may purchase or request a service from the brand, who then assigns a provider to deliver the service. Alternatively, customers may solicit a service from the brand, which then relays the request to multiple providers that can compete to provide the service to the customer.

Systems exist today to allow providers to message customers and manage relationships. However, these systems are designed for messaging and building relationships between one provider and its customers, not for an SDN, where the service requires the customer to interact with more than one provider.

Furthermore, there are systems allowing providers to exchange data and hand-off responsibility in a workflow, such as when brand's e-commerce system hands-off delivery responsibility to a shipping company. The shipping company may message the customer about delivery expectations as a result of the order placed with the brand. However, these are specific integrations with a single service provider (the shipping company) who makes integration points accessible to the brand.

Additionally, systems exist that allow a brand to message a customer with information about how to contact a provider and to simultaneously message a provider to remind them to contact the customer. However, these systems do not reliably connect the customer to the provider. The available systems require either the provider or the customer to take action to communicate.

With all the available systems, the customer has no direct contact with the provider. Instead, the customer relies upon the brand to notify the provider, and the provider to respond promptly to the customer. Suppose the customer has a question about the service or a change in circumstances such as the availability of the customer to receive the service. In that case, the customer must contact the brand and hope that the brand can pass on the information to the provider accurately and in a timely manner and that the provider understands the question or change request. The provider my rely upon the brand to communicate with the customer. If the customer and the provider desire to communicate directly, they must work to get each other's attention and contact information independently of the brand.

The customer's experience with all the providers responsible for delivery of the service reflects on the customer's satisfaction with the brand and brand's ability to retain the customer. Accordingly, brands would like to have greater control of the customer's experience with the provider. However, providers are independent companies that may provide services to customers from other brands or directly to their customers. Furthermore, brands that control the operations of providers run the risk of the providers being classified as employees and not independent businesses by regulatory bodies. Thus, brands need a way to control some aspects of the customer's experience and to have visibility of some of the activities of the providers without exercising complete control and nullifying the independence of the providers.

The customer's experience also reflects upon the provider. For many services, the provider may have the opportunity to provide services to the customer directly after the initial introduction through the brand. The provider may need a record of their interactions with the customer to carry forward with future interactions. Providers need a simple system they can use as their own, independent of the brands the providers work with. Systems for small businesses to message customers directly allow providers to record interactions with their customers and are designed to be used directly by the small businesses. Some of these systems support integration with external systems. However, small business providers rarely have separate IT staff to manage complex systems or integrations with one or more brands that rely upon the providers to deliver services. Small business providers need systems to message customers 1) that are already integrated with the brands they work with, 2) that allow the small business providers to easily customize the timing, conditions, and content of automated messages initiated by the brands, and 3) that allow them to provide visibility into the brands of their activity without undermining the independence of their businesses. Furthermore, these systems should be usable independently of any brand and with different brands.

A particular case of an SDN is an online marketplace of providers (e.g., Task Rabbit®, Uber®). The customer uses the marketplace to identify one or more acceptable providers. Some online marketplaces include messaging mechanisms to facilitate conversations between customers and providers to clarify needs, set expectations, and negotiate prices. However, the marketplace infrastructure is provided only to participants in the marketplace where the marketplace itself is the brand, and all the providers are part of the marketplace's service delivery network. Other brands must create this marketplace infrastructure themselves. Providers must then choose to participate in each marketplace separately and manage conversations in each marketplace's unique messaging infrastructure. Finally, each marketplace maintains its customer records, forcing providers to consult multiple marketplaces to have a single view of customer activity.

### SUMMARY

The following is a summary of the invention to provide a basic understanding of some aspects of the invention. This summary is not intended to identify key/critical elements of the invention or to delineate the scope of the invention. Its sole purpose is to present some concepts of the invention in a simplified form as a prelude to the more detailed description that is presented later.

According to an example embodiment, a system for managing communications between customers and service providers within an SDN is provided. The system may include a processor and a memory communicatively coupled to the processor and storing instructions executable by the processor. The processor may be configured to receive an event from an operator associated with the SDN. The event may indicate that a request for a service has been received, by the operator, from a customer and assigned, by the operator, to one or more service providers associated with the SDN. The processor may be further configured to ascertain, based on the event, metadata associated with at least one of the customer, the operator, the one or more service providers, the request, and the service. The processor may be further configured to establish, based on the metadata, a channel of communications between the customer and the one or more service providers. The processor may be further configured to manage the channel of communications between the customer and the one or more service providers while the request for the service is pending.

According to another example embodiment, a method for managing communications between customers and service providers within an SDN is provided. The method may commence with receiving, by a processor, an event from an operator associated with the SDN. The event may indicate that a request for a service has been received, by the operator, from a customer and assigned, by the operator, to one or more service providers associated with the SDN. The method may include ascertaining, by the processor and based on the event, metadata associated with at least one of the customer, the operator, the one or more service providers, the request, and the service. The method may then continue with establishing, by the processor and based on the metadata, a channel of communications between the customer and the one or more service providers. The method may further include managing, by the processor, the channel of communications between the customer and the one or more service providers while the request for the service is pending.

These and other features, aspects, and advantages of the present systems and methods will become better understood with references to the following figures and description. This summary is an introduction of the concepts. Additional aspects and advantages of this invention will be apparent from the following detailed description of preferred embodiments, which proceeds with reference to the accompanying drawings.

### BRIEF DESCRIPTION OF THE DRAWINGS

Embodiments are illustrated by way of example and not limitation in the figures of the accompanying drawings, in which like references indicate similar elements.

FIG. 1 is a block diagram showing an example environment, in which a system and a method for managing communications between customers and service providers within an SDN can be implemented.

FIG. 2 illustrates a conversation management flow provided by a system for managing communications between customers and service providers within an SDN, according to an example embodiment.

FIG. 3 is a block diagram illustrating components of a system for managing communications between customers and service providers within an SDN, according to an example embodiment.

FIGS. 4A and 4B show tables storing data related to SDN relationships between entities, according to an example embodiment.

FIG. 5 is a block diagram illustrating operations performed by a collaborative conversation orchestration unit of a system for managing communications between customers and service providers within an SDN, according to an example embodiment.

FIG. 6 is a block diagram that illustrates synthesizing a message using data associated with an SDN, according to an example embodiment.

FIG. 7 is a block diagram showing the operation of a collaborative conversation orchestration unit to collaboratively compose a conversation label, according to an example embodiment.

FIG. 8 is a block diagram showing a method for managing communications between customers and service providers within an SDN, according to an example embodiment.

FIG. 9 is a high-level block diagram illustrating an example computer system, within which a set of instructions for causing the machine to perform any one or more of the methodologies discussed herein can be executed.

### DETAILED DESCRIPTION

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is, therefore, not to be taken in a limiting sense, and the scope is defined by the appended claims and their equivalents.

The present disclosure provides systems and methods for managing communications between customers and service providers within an SDN. The SDN may be associated with a brand and a service provider may be part of a network of third parties providing services on behalf of the brand. The system and method enable one or more brands to define, initiate, manage, store, and analyze conversations and conversational workflows between a brand, a provider and a customer, or a brand and a provider, or a brand and a customer, or a provider and a customer in an SDN. According to one embodiment, systems and methods of the present disclosure enable one or more entities to define, initiate, manage, store, and analyze conversations and conversational workflows between other independent entities and an individual in an SDN. The systems and methods further enable one or more brands to define, initiate, manage, store, and analyze conversations and conversational workflows for one or more providers to deliver services to one or more customers with the purpose of collaboratively engaging the one or more customers in anticipation of their needs and in response to their requests.

A brand may be an independent entity engaged in providing products and services to customers, a business entity engaged in providing products or services, an organization engaged in activities requiring interactions with individuals, a governmental organization (e.g., a city authority) responsible for providing services through third parties (e.g., waste collection, transfer, disposal, and recycling service providers, emergency responders, social services providers) to its residents/citizens, health care organizations coordinating care across multiple providers for patients, a third-party aggregator of service providers on behalf of other brands such as a marketplace, automotive service brands with networks of roadside service providers or auto repair shops, insurance brands selling and servicing their products through networks of independent insurance agents or adjusters, logistics brands coordinating shipments and deliveries through independent network of transportation providers, retain financial service brands servicing debt through third-party loan providers, and other entities. A customer may be an individual procuring services or products from the brand or an individual interacting with the brand. A provider may be an independent entity or a business entity engaged in delivering or providing product and/or services to the customer on behalf of the brand or another business entity partnering with the brand to provide services and products to the customer or an independent business entity directly providing services to their customers.

A network of service providers of the brand can encompass thousands of individual providers ranging from single person businesses to large organizations. By standardizing conversational customer engagement across the SDN, brands can significantly improve customer satisfaction with the system of the present disclosure.

In an example embodiment, a brand creates an event in response to a service request from a customer. For a given service, the brand may create more than one event. The systems and methods have the ability to interpret more than one event related to a single service request and ignore subsequent events generated in relations to the same service.

According to an example embodiment, an entity may define and establish an SDN representing and including relationships with a second entity or another entity and roles these first, second, and other entities play in the SDN. These relationships and roles are instrumental in determining responses to events and access to data in a conversational workflow. Specifically, brands may identify and invite one or more providers, and the providers may acknowledge and accept membership in the SDN. The providers may then come on board and become participants in the SDN.

A first entity may integrate their own and third-party applications and systems to define one or more events and other actions to initiate, interject, or close conversations between a second entity or another entity and an individual. Specifically, brands may integrate their systems with the system of the present disclosure to open, add to, or close conversations between their providers (participants in the SDN) and their customers.

According to an example embodiment, the system of present disclosure allows defining a conversational workflow. The conversational workflow may include a sequence of steps taken during a conversation, where some steps can be sequential, parallel, or looped to the previous steps. To define a conversational workflow, a brand may define a set of conditions that must be met when an event is posted by the brand to cause a message to be sent, from a provider associated with the brand and identified in data associated with the event, to a customer of the brand as specified in data associated with the event. When defining the conversational workflow, the brand may further define a set of conditions that must be met by the content of a conversation between a provider and a customer to cause a message to be sent from the provider to the customer. The content of the message may be defined by data passed by the brand or data synthesized based on algorithms, statistical, or machine learning models provided or identified by the brand.

Additionally or alternatively, the content of the message may be defined by a template provided by the brand or a form based on algorithms, statistical, or machine learning models provided or identified by the brand. The conditions for sending the message from the brand to the customer may be further constrained by conditions or data defined by a specific provider. In many embodiments, the content of the message may be further defined by data from the provider or by action of the provider. The conditions for sending the message may be further constrained by conditions or data defined by a specific customer.

In an example embodiment, for initiating the conversational workflow, at least one event may be received from at least one authorized source and submitted to a processor that retrieves the identity of the brand, the provider, and the customer from metadata associated with the event. The processor then applies the appropriate conditions based on the identified brand, provider, and customer to determine whether a message needs to be sent, the content of the message, the originator of the message, the timing of the message, and the medium by which the message is to be transmitted. In various embodiments, if and when a message is sent, a conversation is created (“opened”) and associated in a data warehouse unit of the system with the brand, the provider, the customer, and other specifics, which may include the definition of the service to be provided and the product for which the service is to be provided.

To manage a conversational workflow, the system may provide an application running on a user device of one or more individuals (employees, contractors, and other authorized associates) authorized by the provider. The application may be configured to send and receive messages from customers and notify the individuals authorized by the provider based on their roles and relationships of the individuals as defined by the context of the SDN in which the provider and customer are engaged.

Moreover, the system may provide storing conversational workflow. Specifically, the system may include a data warehouse configured to store data concerning customers, providers, brands, services, conversations, transactions, orders, products and other data related to the SDN. The authority to view, access, and modify data within the data warehouse may be based on roles and relationships defined by the SDN in which the entities in the data warehouse are participating. For example, a customer record, which is defined originally by a brand, may only be viewed by those providers that the brand has asked to provide service to the customer, and providers may only view those aspects of the customer record that are relevant to the service they are providing that customer. In turn, the brand may only view the information provided by the brand and may not, unless granted permission, view the conversational data between the customer and provider. The same customer record may also include data about service interactions from other SDN relationships with other brands and other providers which are not accessible by the originating brand or providers. The customer may control which brands and providers can access the data of the customer.

Furthermore, the system may provide analyzing conversational workflows. Specifically, the system may assess one or more analytical applications available to brands, providers, and customers and provide statistical, mathematical, and machine learning models and dashboards against data from the data warehouse. The analytical applications may be accessible based on roles and relationships defined by the SDN in which the brands, providers, and customers participate. An analytical application for a brand may include a dashboard illustrating activity for one or more providers in a given SDN with the ability to drill down to a given provider to see the individual activity of the provider including conversations of the provider, in the context of granting those permissions by the SDN.

In an example embodiment, the system may include a processor configured to enable providers to conduct conversations with one or more individual customers via various communication channels, such as Short Message Service/Multimedia Messaging Service (SMS/MMS) text messaging. The customer may include a single customer or a group of customers (e.g., when a group chat is established between a provider and more than one customers (e.g., family members, a group of travelers, and so forth). The system may provide an Application Programming Interface (API) enabling different brands to initiate and manage conversations on behalf of providers that have agreed to deliver services on behalf of the brand. The system further includes a database connected to the API and the processor. The database may store relationships between brands and providers and may be used by the API to interpret requests of the brand correctly and initiate and manage conversations on behalf of the appropriate providers.

The system may interpret an event in the API based on the information provided by a brand through the API and data stored in the database. Based on the interpretation of the event, the system may initiate and manage conversations between the appropriate provider and customer.

The system may further have the ability to interpret the event to signify that the same service has been reassigned or transferred from one provider to another provider or from the original provider to a new provider. The system may interpret the event in the API based on information provided by a brand through the API and in the database. Based on the interpretation of the event, a conversation with a customer may be transferred from one provider to another provider.

The system may further perform conversations redundancy elimination. Specifically, the system may interpret an event in the API based on information provided by a brand through the API and in the database. Based on the interpretation of the event, the system may ignore the event and avoid sending redundant messages from the provider to the customer.

The system may further perform conversation closing. Specifically, the system may interpret an event in the API based on the information provided by a brand through the API and in the database. Based on the interpretation of the event, the system may send a message and close a conversation between a provider and a customer.

The system may further provide control of conversations from the provider side. Specifically, the system may interpret an event in the API based on the information provided by the brand through the API, the information provided by a provider, and the relationship as defined in a database. Based on the interpretation, the system may determine whether, at what time, and in what form a conversation between a provider and a customer is to be initiated, interjected, managed, transferred, closed, or otherwise affected.

The system may further provide control of conversations from the customer side. Specifically, the system may interpret an event in the API based on information provided by a brand through the API, the information provided by the provider, the information provided by the customer, and the relationship as defined in the database. Based on the interpretation, the system may determine whether, at what time, and in what form the conversation between a customer and a provider may be initiated, interjected, managed, transferred, closed, or otherwise affected.

The system may further provide message definition. Specifically, the system may construct a human-readable message based on the input parameters. The system may further synthesize input parameters for the custom message definition based on data, algorithms, or models from multiple sources including the brand, the provider, the customer, historical information, or conversational data.

The system may further provide labels associated with conversations. Specifically, the system may construct a human-readable conversation label which can be used by a provider or a user associated with the brand of a conversation portal to identify conversations in the conversational portal based on input parameters. The system may synthesize input parameters for the custom conversation label definition based on data, algorithms, or models from multiple sources including the brand, the provider, the customer, historical information, or conversational data.

The system may further provide notifications associated with conversations. Specifically, the system may notify a provider or a user associated with the brand about a new message as received from a customer based on the input parameters. The system may enable the provider or brand users of the system to determine what action should be taken, if any, with regard to the notification based on input parameters. The system may further synthesize input parameters for the notifications based on data, algorithms, or models from multiple sources including the brand, provider, customer, historical information, or conversational data. The system may further synthesize input parameters for the custom notifications based on data, algorithms, or models from multiple sources including the brand, the provider, the customer, historical information, or conversational data.

The system may further include a collaborative conversation orchestration unit configured to provide a programmable means for one or more entities to define, initiate, and manage conversations between other entities and their common customers based on their roles and relationships in the SDN managed by the system. The system may further include a conversation portal configured to provide an application for user devices of a given entity such as a provider or brand, including the provider's or brand's employees, contractors, and other authorized associates, to initiate, conduct, manage, and review conversations with customers and other entities that also use the system. The system may further include a communications unit configured to connect the system to communications infrastructure preferred by customers or providers, in order to send and receive communications from customers and providers. The system may further include a data warehouse unit that is a shared, authorization-controlled data storage of data associated with brands, customers, providers, services, conversations, and communications for all SDNs managed by the system. The system may further include a business intelligence unit that provides analysis of data stored in the data warehouse unit for authorized brand, provider or customer users of the system based on their roles and relationships in the SDNs managed by the system.

Thus, the system of the present disclosure is a messaging-based customer engagement platform for SDNs to conduct conversations with their customers, suppliers, and other providers in their ecosystems. As messaging becomes the preferred means of communication for most consumers, the system can help providers be more responsive, more connected, and more efficient in their interactions resulting in measurably happier customers. The system uniquely facilitates seamless hand-off of customer conversations between enterprise CRM and operations systems and the providers assigned deliver the service or product.

In an example embodiment, the system may enable a provider to use a simple web portal or native iOS® or Android® applications running on a user device of the provider to start a conversation with a customer over SMS. Customers can only see SMS messages and are able to use the text messaging applications that may be default messaging applications running on users devices of the customers. Each employee of the provider can manage and participate in any conversation with any customer by selecting the conversation from the customer conversations list and entering a message. Employees can initiate conversations with new customers (that authorize the provider to use SMS to communicate) by entering their phone number and name. The system uses a message template, customizable for each employee, to create and send a welcome message. The employees can add profile information about each customer to help identify customers and maintain useful customer data.

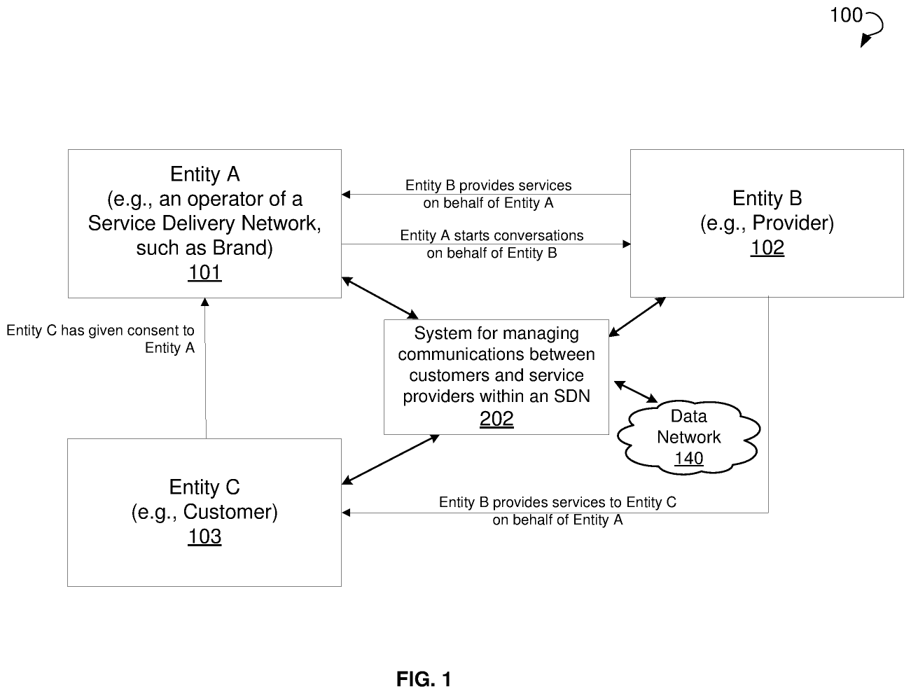

Referring now to the drawings, FIG. 1 shows an example environment 100, in which a system and a method for managing communications between customers and service providers within an SDN can be implemented. The environment 100 may include an entity A 101 (e.g., an operator of an SDN, such as a brand), an entity B 102 (e.g., a product or service providers also referred to herein a provider), an entity C 103 (e.g., a customer), a system 202 for managing communications between customers and service providers within an SDN, and a data network 140.

The entity A 101 is an enterprise brand, or a brand, which may be a user of the system 202 and an API provided by the system 202 and may have a valid set of credentials and a mapping of unique identifiers to providers. A brand has to have a contractual relationship with each provider of the system 202 that allows the brand to initiate conversations between customers and providers.

The system 202 is organized around the concept of a provider (the entity B 102) interacting with a customer and other providers. A provider can be established when a user registers a new provider account, provides a phone number, and establishes a subscription for the provider. At the time the provider is established, a messaging phone number for SMS/MMS messaging may be provisioned or the provider phone number can be hosted to allow the provider phone number to become the messaging phone number and be used to send/receive SMS/MMS messages.

The user who registers the provider is the first employee of the provider and is automatically given an administrator role. Employees with the administrator role can add employees who are given the employee role. Each employee can have a user account and signs in using the provider phone number, their username, and a password they define upon initial sign-in.

Upon assigning a request for a service received by the brand from a customer to a provider, the system 202 can automatically create a new customer (entity C 103) and store the customer phone number and additional metadata including a customer first name and a customer last name in the customer profile. The provider does not have to perform any steps to enter data related to the new customer. The system 202 can automatically start a conversation with the customer on behalf of the provider. In an example embodiment, the provider can add additional details about the customer in the customer profile. Customers exist independently of providers. If an employee of another provider begins a conversation with a customer whose customer phone number has already been used in the system 202, the existing customer record is used and any generic customer profile information may be made available to that other employee and other provider.

A conversation is a collection of messages between an employee of a provider and a customer. The conversation is private to the provider and not visible by other providers. The conversation is visible to all other employees of the provider, allowing any employee to follow-up with any customer. Conversations become open when an employee starts a conversation with an existing or new customer or when a customer sends a message to the messaging phone number. Conversations are closed when a provider closes the conversation or when the number of open conversations exceeds a system limit. The conversation list shows all the open conversations. An employee can select an open conversation and to review a message from a customer or to send a new message.

Employees of the provider can send messages to a customer, and customers can send messages to employees of the provider. Messages can include text, emoji, images (transmitted as MMS), or files (such as pdf, sent as temporary Uniform Resource Locators (URLs)).

FIG. 1 depicts relationships in an SDN, specifically, a contractual relationship that may be established between entities responsible for delivering a service, such as a brand, a provider, and a customer, allowing conversations to be initiated, conducted, and managed by the SDN between the brand, the customer, and the provider. Moreover, a contractual relationship may be established between a brand and a customer, a brand and a provider, or a provider and a customer. To participate in the system 202, a customer may be asked to provide certain permissions as part of the then-current regulatory program and brand's contractual terms requesting the customer to opt-in or opt-out from certain type of interactions or messages which may be shared as part of the relationship to be formed in the SDN. Once the customer, brand, and/or provider enters into a relationship to participate in the system 202, the system 202 may allow the customer, the brand and the provider to send messages in real time to each other for current updates about the products and services procured from the brand and to be delivered by the provider.

By way of example, FIG. 1 illustrates an SDN consisting of two entities, the entity A 101 and the entity B 102 that together provide a service to the entity C 103. The entity C 103 is a direct customer of the entity A 101 and has requested a service from the entity A 101. As a consequence of its customer relationship with the entity A 101, the entity C 103 provides consent to the entity A 101 to send communications to the entity C 103. Required and essential contractual language may be included in the agreement defining the relationship of the entity A 101 and the entity C 103 to extend that consent to allow related parties to provide communication to the entity C 103 and deliver the requested service to the entity C 103.

In an example embodiment, the entity B 102 may have an existing contract in place in advance with the entity A 101 to provide services. In another example embodiment, the entity B 102 may be contracted by the entity A 101 upon the receipt of the request. In particular, the entity B 102 may be contracted to provide services to the entity C 103 on behalf of the entity A 101. Mandatory and essential contractual language may be included to grant the entity A 101 permission to start conversations on behalf of the entity B 102 with customers such as the entity C 103. Such conversation may happen only if the entity A 101 has the required consent for such conversations from the entity C 103. As a consequence of its customer relationship between the entity A 101 and the entity C 103, the service provider relationship between the entity A 101 and the entity B 102, and the essential contractual language heretofore described, the entity B 102 may be permitted to provide communication to the entity C 103 to deliver the services to the entity C 103 and the entity A 101 may be permitted to start conversations between the entity B 102 and the entity C 103 to facilitate entity B 102 delivering the services to the entity C 103 on behalf on the entity A 101.

Each of the entity A 101, the entity B 102, and the entity C 103 may have user devices and may use the user devices to communicate with the system 202. A user device of any of the entity A 101, the entity B 102, and the entity C 103 may include, but is not limited to, a laptop, a desktop computer, a tablet computer, a phablet, a personal digital assistant, a media player, a mobile telephone, a smart television set, in-vehicle infotainment, a smart home device, a personal computing device, a smartphone, and the like.

In certain embodiments, the user devices of the entity A 101, the entity B 102, and the entity C 103 and the system 202 may be connected to and may communicate with each other using the data network 140. The data network 140 can refer to any wired, wireless, or optical networks including, for example, the Internet, intranet, local area network (LAN), Personal Area Network, Wide Area Network (WAN), Virtual Private Network, cellular phone networks (e.g., a Global System for Mobile (GSM) communications network, a packet switching communications network, a circuit switching communications network), Bluetooth® radio, an Ethernet network, an IEEE 802.11-based radio frequency network, a Frame Relay network, an Internet Protocol (IP) communications network, or any other data communication network utilizing physical layers, link layer capability, or network layers to carry data packets, or any combinations of the above-listed data networks. In some embodiments, the data network 140 includes a corporate network, a data center network, a service provider network, a mobile operator network, or any combinations thereof.

In some embodiments, the system 202 may be implemented as a server(s) or a cloud-based computing resource(s) shared by multiple users. The system 202 can include hardware and software available at a remote location and accessible over the data network 140. The system 202 can be dynamically re-allocated based on demand. The cloud-based computing resource(s) may include one or more server farms/clusters including a collection of computer servers that can be co-located with network switches and/or routers.

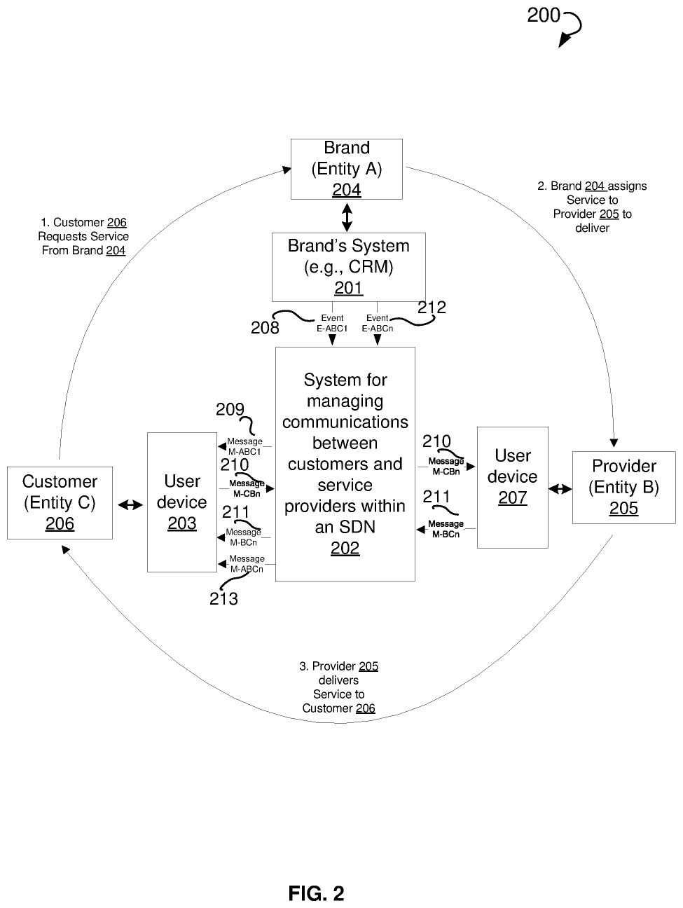

FIG. 2 illustrates a conversation management flow 200 provided by the system 202 for managing communications between customers and service providers within an SDN, according to an example embodiment. The use of the system 202 is shown in the context of an SDN consisting of a brand that provides a service through a provider to a customer.

In FIG. 2, a customer 206 (entity C) requests or purchases a service from a brand 204 (entity A). A request for the service may occur online or in-person at a retail location or otherwise. By way of example only, the service may be a result of purchasing a product that requires the service to be installed. The service may be sold separately or as part of a subscription. The service may be included in a request when the brand 204 introduces one or more potential providers of the service. The introduction may include, for example, a referral to a real estate agent where the referrer is the brand 204 and the agent is the provider 205 and the service is the brokering of a future real estate purchase for the customer 206. When the request is made to the brand 204, the request for the service may be entered into the brand's system 201 directly by the customer 206 or by an agent or employee of the brand 204. The brand's system 201 may automatically or through the actions of the brand's agents or employees assign the service to the provider B 205. The provider 205 is expected to deliver the service to the customer 206.

In an example embodiment, the brand's system 201 may include a Customer Relationship Management (CRM) system of the brand 204. The brand 204 may use the CRM system for storing all data related to provision services by a plurality of providers, on behalf of the brand 204, to a plurality of customers.

FIG. 2 further illustrates how the system 202 manages conversations between the provider 205 and the customer 206 regarding the service to be provided by the provider 205 to the customer 206 on behalf of the brand 204. FIG. 2 also depicts the use by the brand's system 201 of the system 202 to initiate and manage conversations between the provider 205 and the customer 206 regarding the delivery of the service to improve the experience of the customer 206 and to reduce the costs for the brand 204 and the provider 205 by eliminating poor service delivery.

When the brand 204 assigns the service to the provider 205 to deliver, the brand's system 201 sends an event 208 E-ABC1 to the system 202 to establish a channel of communications and initiate a conversation between the provider 205 and the customer C 206 regarding the service. Specifically, a processor associated with the system 202 may receive the event 208 E-ABC1 from an operator associated with the SDN. The event 208 E-ABC1 may indicate that a request for a service has been received, by the operator, from the customer and assigned, by the operator, to one or more service providers associated with the SDN. In an example embodiment, the operator associated with the SDN may include a brand enterprise shown as the brand 204. The operator may include a human operator associated with the brand enterprise. In another example embodiment, the operator may include a non-human operator associated with the brand enterprise. The non-human operator may include a website associated with the brand enterprise, a bot associated with the brand enterprise, a software application running on a server associated with the brand enterprise, and so forth. The one or more service providers shown as the provider 205 may part of a network of third parties (i.e., the SDN) providing services on behalf of the brand enterprise.

Based on the event 208 E-ABC1, the processor of the system 202 may ascertain metadata associated with at least one of the customer 206, the brand 204, the one or more service providers (such as the provider 206), the request, and the service. In an example embodiment, the metadata may include at least one of the following: a name of the customer 206, a phone number of the customer 206 (such as an SMS and MMS enabled phone number of the customer), a location of the customer 206, pricing information, and so forth.

Based on the metadata, the processor of the system 202 may establish a channel of communications between the customer 206 and the one or more service providers. In an example embodiment, the channel of communications may include an SMS/MMS channel of communications. The processor of the system 202 may manage the channel of communications between the customer 206 and the provider 205 while the request for the service is pending. In an example embodiment, the channel of communications may be established using a plugin API. The plugin API may be configured to automatically construe messages associated with the communications. The plugin API may be integrated with a CRM system or a dispatch system of the brand 204 associated with the SDN.

In an example embodiment, the processor of the system 202 can be configured to require the operator to confirm that the customer 206 has provided an opt-in to allow the operator to communicate via the SMS/MMS channel of communication. The processor may be further configured to prompt the operator to extend the opt-in to the service provider solely to address the request for the service.

In an example embodiment, the establishment of the channel of communications may include providing a communication initiation message to a user device associated with the customer 206. The communication initiation message may be provided via a default messaging application running on the user device. The default messaging application may include any messaging application provided by default on the user device. Specifically, to establish the channel of communications, the system 202 may form the communication initiation message (also referred to herein as a welcome message) shown as a message 209 M-ABC1 (e.g., an SMS message, a message in a messaging application, such WhatsApp®, Facebook Messenger®, Skype®, and so forth). The system 202 may send the message 209 M-ABC1 to the user device 203 of the customer 206 from a phone number established for the provider 205 or through another communication device. In an example embodiment, the principles of engagement of the customer 206 for the SDN may further include coordinating phone calls, video meetings, and so forth. The message 209 M-ABC1 may be formed and sent based on the conditions set by the brand 204, the provider 205, and the customer 206 and the metadata associated with the event 208. The message 209 M-ABC1 may introduce the provider 205 to the customer 203 and include initial information about the service to be provided by the provider 205 on behalf of the brand 204. Following such a conversation route, the system 202 may open the channel of communications between the provider 205 and the customer 206 and provide the customer 206 with an opportunity to confirm or update the expectations for the service.

In an example embodiment, the establishment of the channel of communications may include providing, via a web application or a mobile application, a user interface to the provider 206 and/or a representative of the brand 204. The management of the channel of communications may be at least partially performed by the brand 204 using the user interface.

In the absence of the system 202, the brand 204 has no means to reliably establish the direct communication between the customer 206 and the provider 205. Furthermore, in the absence of the system 202, the brand 204 is dependent on employees of the provider 205 performing several steps including, among others (1) noticing that the brand 204 has assigned the service to the provider 205; (2) deciding to reach out to the customer 206; (3) having a reliable means of communicating with the customer 206; (4) correctly entering the contact information of the customer 206 into whatever system the provider 205 may use to communicate with customers; (5) establishing a connection with the customer 206, who may not know the provider 205, through the communication system; and (6) correctly communicating the information that the provider 205 has been given about the service to the customer 206. Furthermore, with available conventional technologies, the brand 204 has no visibility of whether the provider 205 has communicated with the customer 206, no visibility or control over the timing of the communication, and no visibility or control over the content or form of the initial message from the provider 205 to the customer 206. With the use of the system 202, the customer 206 receives an initial message from the provider 205 with no action required on the part of the provider 205 or its employees.

The management of the channel of communications may further include receiving one or more messages from the customer 206. The one or more messages may be provided by the customer 206 using the default messaging application. Specifically, the customer 206 may send a message 210 M-CBn (e.g., an SMS message) using the user device 203 in response to the message 209 M-ABC1. The system 202 receives the message 210 M-CBn and, upon receipt, may notify one or more employees of the provider 205 who have user accounts in the system 202, based on data provided about the service, the content and timing of the message 210 M-CBn, data about the provider 205 and configuration defined by the provider 205. In particular, the system 202 may provide the message 210 M-CBn to the provider 205 using the user interface.

The employees of the provider 205 can use a user device 207 to view the message 208 M-ABC1, the message 210 M-CBn, selected information about the customer 206, information about the service, and conversation history that the provider 205 has had with the customer 206. Specifically, the user device 207 may have a user interface associated with the system 202. The user interface may be visible through a web browser or through a native mobile application of the user device 207 or through other means. Depending on data provided about the service, the content and timing of the message 210 M-CBn, data about the provider 205 and configuration defined by the provider 205, one or more employees of the provider 205 may respond to the message 210 M-CBn with their own message 211 M-BCn. The system 202 may receive the message 211 M-BCn from the provider 205. The message 211 M-BCn may be provided by the provider 205 using the user interface. The system 202 may send the message 211 M-BCn to the user device 203 associated with the customer 206 via the default messaging application of the user device 203. The message 211 M-BCn may be sent to the customer 206 as an SMS text message from the phone number assigned to the provider 205 or other communication channel preferred by or used by or recommended by or for the customer 206.

The message 209 M-ABC1, message 210 M-CBn, message 211 M-BCn, and so forth are collected in a conversation ABC1 about the service. The system 202 thus allows for the exchange of messages between various entities using the system 202 such as the provider 205 and the customer 206 as shown in FIG. 2, thereby improving the quality of the service delivery.

With the available conventional technologies and platforms, the brand may send a message directly to the customer, and the customer may respond; however, the responses can go to the brand and not to the provider. Furthermore, provider's employees may not be aware of messages sent from the brand to the customer with regard to the service. The provider cannot automatically have information from the brand about the service to be able to control which employee responds to the customer. Furthermore, the provider may need to accurately transcribe all the information about the customer and the service from the brand to provide context for the conversation.

Based on actions taken by the customer 206, the provider 205, or the brand 204 or depending on the content of the conversation, the data concerning the service, or configuration established by the brand 204 or the provider 205, additional messages may be interjected into the conversation between the provider 205 and the customer 206 and actions may be taken regarding the conversation. One example may include an event 212 E-ABCn received from the brand's system 201 as a result of the provider 205 notifying the brand 204 that provisioning of the service in response to the request has been completed. In response to the receipt of the notification and depending on the conditions set by the brand 204, the provider 205, and the customer 206 and the data associated with the event 212 E-ABCn, the system 202 may form and send a message 213 M-ABCn (e.g., an SMS message) to the customer 206. The message 213 M-ABCn may inform the customer 206 that provisioning of the service has been completed. The system 202 may then close the conversation between the provider 205 and the customer 206. The brand 204 can use the system 202 to send a follow-up message inquiring about the quality of the service and checking with the customer 206 to see if there are any unresolved issues. The message may come from the provider 205 automatically providing the provider 205 with the opportunity to resolve issues directly with the customer 206.

With the currently available conventional technologies, the brand may have no ability to exercise any control over provider's conversations with the customer. The provider may have to manually close conversations with the customer when the service is completed.

In general, the purpose of the API (also referred herein to a plugin API) is to facilitate the management of customer conversations, specifically, to allow a brand, on behalf of a provider, to automatically initiate a conversation, end a conversation, and provide parameters to label a conversation and for use in the templated messages.

When the brand receives a request from a customer for a service to be delivered by an independent provider in the SDN, the brand logs the request in the CRM system of the brand. The CRM system initiates a conversation on behalf of the provider in the system (using the API open_service) including passing parameters about the customer and the service to be delivered. The provider continues conversation with the customer in the system and delivers the service. The provider notes the service as completed in the CRM system. The CRM system ends the conversation on behalf of the provider in system (using the API close_service) including passing parameters concerning the customer and the service now delivered.

The API includes both an open_service and close_service to initiate and end conversations between providers and their customers. These services allow the brand to pass data to the system that are used to label conversations and construct messages based on templates under the control of the providers.

To associate a provider with the system 202, an identifier used by the brand to identify the provider may be provided by the brand to the API. The identifier may include a ProviderID, a main phone, a name, an owner first name, an owner last name, owner email, street address, city, state, country, zip code, and so forth. As part of the setup, the system 202 may map the ProviderID to existing providers in the system and may work to on-board the remaining providers. Multiple ProviderIDs can be mapped to a single providers. The system 202 can also provide dedicated onboarding flows that allow providers in the SDN of the brand to onboard themselves.

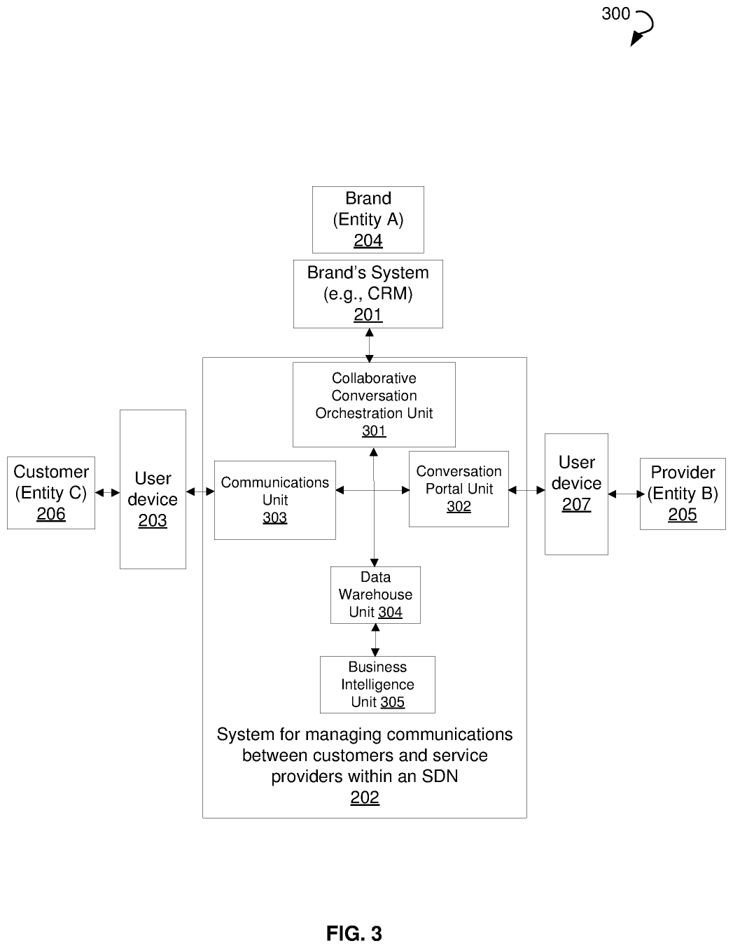

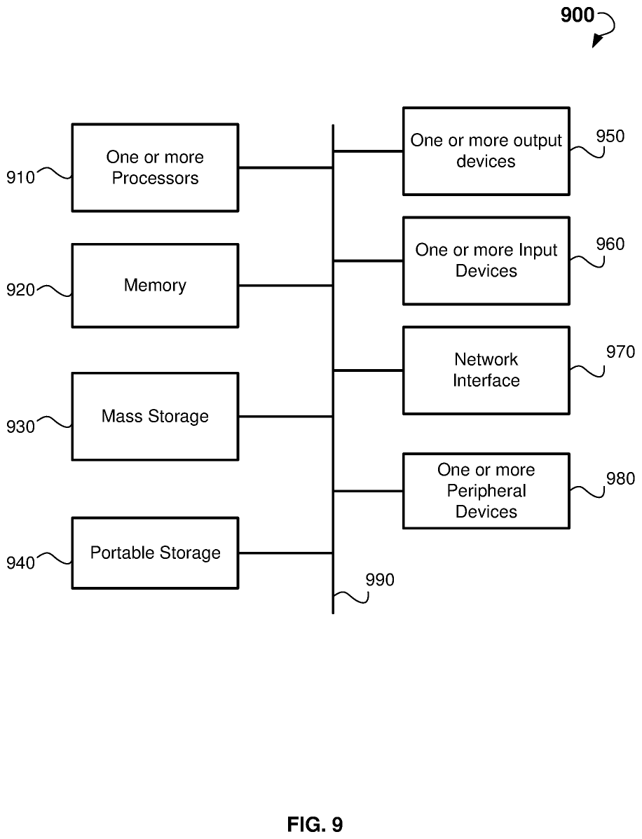

FIG. 3 is a block diagram 300 illustrating components of the system 202, according to an example embodiment. The system 202 may include a collaborative conversation orchestration unit 301, a conversation portal unit 302, a communications unit 303, a data warehouse unit 304, and a business intelligence unit 305. In an example embodiment, the operations performed by one or more of the collaborative conversation orchestration unit 301, the conversation portal unit 302, the communications unit 303, the data warehouse unit 304, and the business intelligence unit 305 may be performed by a processor of the system 202. The processor and a memory communicatively coupled to the processor and storing instructions executable by the processor are described in more detail with reference to FIG. 9.

Referring again to FIG. 3, the collaborative conversation orchestration unit 301 provides a programmable means for one or more entities such as a brand 204 to define, initiate, and manage conversations between other entities and their common customers based on their roles and relationships in the SDN managed by the system 202. Common customers as used herein are the customers common to the first entity defining the conversation and the second entity delivering the service to the customer on behalf of the first entity.

The conversation portal unit 302 provides an application for a given entity such as a provider 205 (including provider's employees, contractors, and other authorized associates) to initiate, conduct, manage, and review conversations with customers and other entities that also use the system 202. The conversation portal unit 302 can track all conversations for a given entity, which is a part of the conversation, including those initiated by other entities, such as the brand 204, through the collaborative conversation orchestration unit 301. The conversation portal unit 302 provides a user interface for the given entity, such as the provider 205, to exercise control over the ability for other entities, such as the brand 204, to initiate and manage conversations between the given entity and customers, such as the customer 206.

The communications unit 303 connects the system 202 to communications infrastructure preferred by customers or providers, such as SMS/MMS or other communication channels, to send and receive communications from customers and providers or other entities using means already available to them. The communications unit 303 manages the communication channel, opt-in/opt-out privacy, availability preferences of customers concerning different entities who may or are participating in the system 202 and their roles and relationships in the SDNs with which the customer is engaged.

The data warehouse unit 304 is a shared, authorization-controlled data storage of all brand, customer, provider, service, conversation, and communication data for all SDNs managed by the system 202. The data warehouse unit 304 stores the roles and relationships for entities, providers, and customers in the context of the SDNs in which they participate. The data warehouse unit 304 manages the access to data based on the roles and relationships in the SDN.

The business intelligence unit 305 provides analysis of data stored in the data warehouse unit 304 for customers and authorized users of the brand 204 or the provider 205 based on their roles and relationships in the SDNs managed by the system 202.

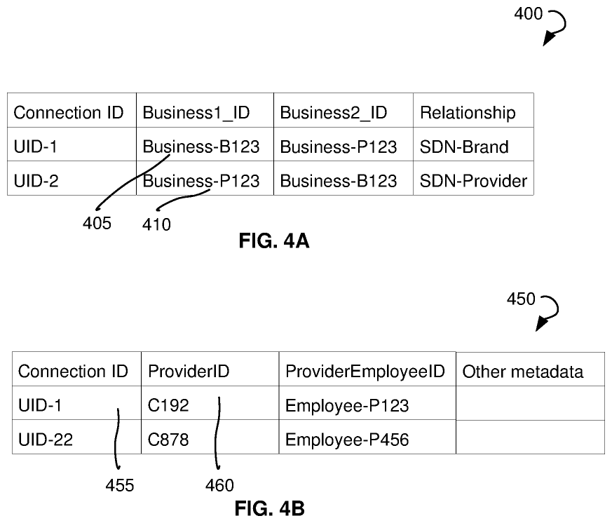

FIGS. 4A and 4B show tables storing data related to the SDN relationships between entities, according to an example embodiment. FIG. 4A shows a connections table 400 illustrating relationships captured between different entities using the system 202. FIG. 4B shows a connection metadata table 450 illustrating information about the relationships captured between different entities using the System 202. The tables 400 and 450 are maintained in the data warehouse unit.

In the SDN, each entity may be represented with a unique identifier, such as a Business-B123 405 or Business-P123 410. Separate tables in the data warehouse unit may store additional information about the entities. The connections table 400 captures the relationships between business entities in the SDN. In the connections table 400, Business-B123 405 is in an SDN-Brand relationship with Business-P123 410, and Business-P123 410 is in an SDN-Provider relationship with Business-B123 405. The relationships are uniquely identified in the connections table 400 so they may be referenced elsewhere.

The connections metadata table 450 captures additional information about the relationship between the entities that can be used by the system 202. For example, the connections metadata table 450 shows that a connection UID-1 455, defined earlier in the connections table 400, has the ProviderID 460 “C192,” which represents the unique identifier used by an internal system of the business-B123405 to identify the specific business, i.e. the business-P123 410. If an event E-ABC1 is sent by the business-B123 405 that references “C192”, the system 202 may know that any conversation action is to be taken with reference to the business-P123 410.

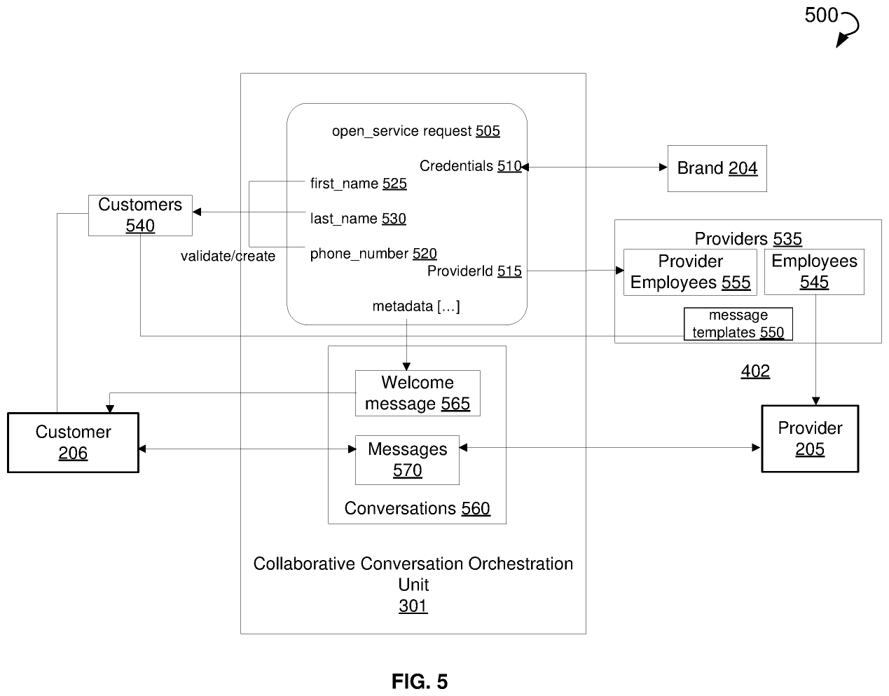

FIG. 5 is a block diagram 500 illustrating operations performed by a collaborative conversation orchestration unit 301 of the system 202 to enable a brand to initiate a conversation, on behalf of a provider, with a customer, according to an example embodiment. As discussed above, the collaborative conversation orchestration unit provides a programmable means for one or more entities to define, initiate, and manage conversations 560 between other independent entities and their common customers based on their roles and relationships in the SDNs managed by the system 202.

In an example embodiment, the collaborative conversation orchestration unit 301 incorporates an API such as a Representational State Transfer (REST) API organized around two endpoints, open_service request 505, and close_service request. FIG. 5 illustrates the operation of the open_service API. The components of the open_service API when a open_service request 505 is made to the open_service API can be as follows.

Credentials 510 is a component that identifies the brand 204 that initiates the conversation. The credentials 510 are verified to ensure that the brand 204 has the authorization to make the open_service request.

ProviderID 515 is an internal identifier of the brand 204 for the given provider 205, for which the brand 204 initiates a conversation with the customer 206. The collaborative conversation orchestration unit 301 can look up the identity of the provider corresponding to the ProviderID 515 in the connections metadata table storing data related to a plurality of providers 535 having a plurality of provider employees 555.

Phone_number 520 is the phone_number of the customer 206 that may receive the initial message from the phone number of the provider. The collaborative conversation orchestration unit 301 can look up the customer 206 in the data warehouse unit that stores data related to a plurality of customers 540. If the customer 206 does not exist in the data warehouse unit, the collaborative conversation orchestration unit 301 may verify that the phone number is capable of receiving text messages and create a new customer record using the first_name 525 and last_name 530 data fields passed by the brand 204.

When the open_service 505 request is made, the collaborative conversation orchestration unit 301 performs the following operations:

(a) validates the credentials of the brand 204;

(b) validates that the provider 205 exists in the brand's name space as defined by the connections metadata table;

(c) validates that the customer 206 exists or, if not, verifies that the phone_number accepts SMS messages and then creates a new customer record;

(d) validates that the brand's conditions for initiating a conversation between the provider 205 and the customer 206 are met;

(e) validates that the provider's conditions for initiating a conversation between the provider and customer are met;

(f) validates that the customer's conditions for initiating a conversation between the provider and customer are met;

(g) looks up the ProviderEmployeeId identified in the connections metadata table and use the message template or other algorithm or model associated with the provider employee 545 as the basis for an initial message shown as a welcome message 565);

(h) synthesizes the welcome message 565 using one of message templates 550 and data provided from the customer record, the provider record, and the metadata from the brand's open_service request 505, which includes data concerning the service to be provided and has been already stored in the data warehouse unit;

(i) creates a conversation thread in the data warehouse unit between the provider 205 and the customer 206 with the welcome message 565 as the first message;

(j) sends the welcome message 565 to the customer 206 using the communications unit from the phone number established for the provider 205 and stored in the data warehouse unit;

(k) adds the conversation thread in the conversation portal unit with a custom conversation label;

(l) notes the delivery status of messages 570 related to the conversation as indicated by the communications unit in the data warehouse unit and updates the conversation portal unit.

Additional steps may be added to complete the open_service request completion process depending on the event created, customer's specifications, conversations, and other factors.

If the customer 206 replies to the message, the reply is received via the communications unit, captured in the data warehouse unit, and updated in the conversation portal unit for the provider 205. Provider employees 545 may be notified based on conditions and algorithms defined by the provider 205 that utilize parameter data from the brand 204, the customer 206, and other sources in the data warehouse unit.

Thus, the brand's system initiates a conversation between a provider 205 in their SDN and a common customer 206 of the brand 204 and provider 205. When the collaborative conversation orchestration unit receives a close_service request, similar operations are performed with a different message template and the conversation is closed.

An additional table in the data warehouse unit is utilized to track open and close requests for a given combination of ProviderID and phone_number. With this table, additional operations may be performed by the brand 204. By way of example and not limitation, the following operations may be performed by the brand 204. First, if a follow-up open_service request is received from the same brand 204 with the same phone_number and ProviderID before a close_service request is received for the same phone_number and ProviderID, the follow-up open_service request may be ignored based on brand conditions. This way, the collaborative conversation orchestration unit is robust to duplicate requests that may be due to retries or timing issues.

Second, if a follow-up open_service request is received from the same brand 204 with the same phone_number, but a different ProviderID before a close_service request is received for the phone_number and original ProviderID, the follow-up open_service request may be interpreted as a transfer of the service request from one provider to another provider, based on brand conditions. The collaborative conversation orchestration unit 301 may perform transfer operations defined by the brand 204, including the following: sending a transfer message from the original provider to the customer to alert the customer that the service is being reassigned to a different provider, closing the conversation in the conversation portal unit for the original provider, sending a welcome message from the new provider, and opening a new conversation in the conversation portal unit for the new provider.

Providers may have the ability to control how messages and conversations appear using message templates and conversation labels. Providers can also control when the API can send messages by defining hours of operation. Following are the two examples showing how a provider may exercise control over the conversation.

Example 1: An employee with the administrator role within a provider business may choose to disable the welcome message through the conversation portal unit. When this condition is set (and stored in the data warehouse unit), open_service requests from a given brand may be ignored. This allows providers to control when new conversations are allowed to account for temporary staffing issues.

Example 2: An employee with the administrator role associated with a provider may establish hours of operation for the provider. Outside of hours of operation, open_service requests from a given brand may be ignored. This allows providers to prevent new conversations from being initiated when the provider is not open and able to respond to customer replies.

Specifically, when the API receives an open_service request, the system 202 checks to see if a service provision is enabled and if the provider is open based on the hours of operation. Users with the administrator role can disable service provision to ignore all open_service requests. Users with the administrator role can set hours of operations settings to define times when open_service requests may be automatically ignored.

The API may respond to all valid close_service requests. Only the system 202 can disable the API for close_service requests for a given provider that has authorized a brand to start and close conversations for that provider.

In an example embodiment, when the close_service request is received, the system 202 checks to see if a customer with the customer_phone_number already exists in the system 202. If not, the system 202 returns an error. The system 202 further checks to see if an open conversation with the customer and the provider, associated with the ProviderID, already exists. If not, a new conversation is created. The system 202 may construct a message to the customer using parameters passed in the close_service request and the goodbye message template. The system 202 may send the message to the customer and close the conversation.

To avoid duplication of conversations, the API keeps track of open_service and close_service requests for each unique customer_phone_number in order to handle potential duplicates and conversation transfers. To make the service delivery experience more robust to variations in open_service requests, the API associated with the system 202 is configured to ignore open_service requests that meet certain conditions, such as a change in a secondary parameter field, which do not warrant sending a new welcome message. This operation is enabled for all providers by default but is controlled by an internal flag that can be disabled upon request for all or selected providers.

Specifically, the API may ignore follow-up open_service requests for the same customer_phone_number and same ProviderID until a close_service request for the customer_phone_number and ProviderID are received.

To transfer the conversation, if a follow-up open_service request is received for the same customer_phone_number but different ProviderID, the API interprets that as a request to transfer the conversation from the first ProviderID to the second ProviderID. In this event, the API may close the conversation for the first ProviderID with no goodbye message and start a new conversation for the second ProviderID with a new welcome message. The customer may receive an initial welcome message from the first provider's text phone number, and then may receive a second welcome message from the next provider's text phone number.

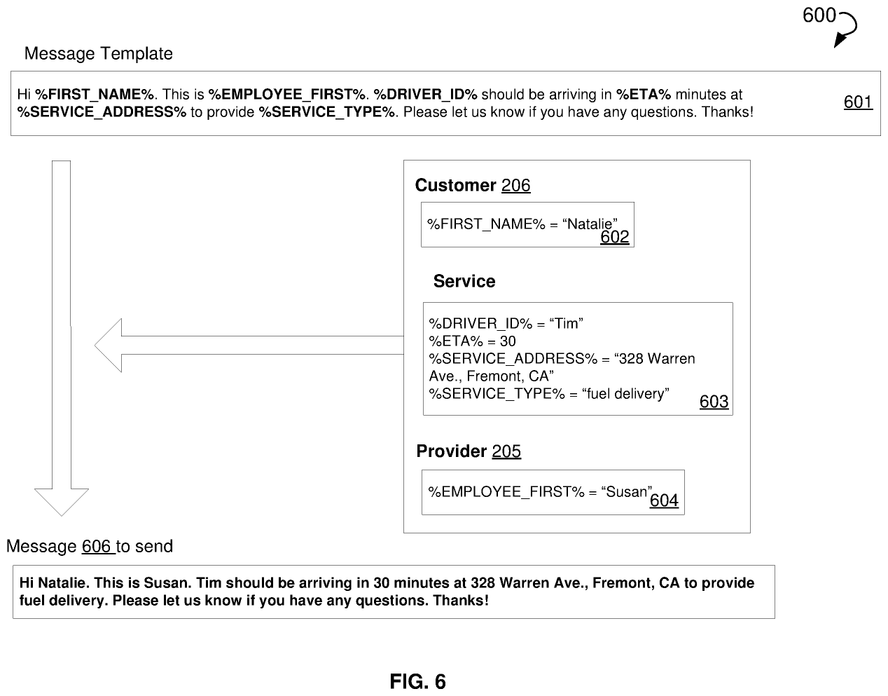

FIG. 6 is a block diagram 600 that illustrates synthesizing a message using data associated with the SDN, according to an example embodiment. Template parameters may be used in conjunction with the welcome message templates (the “Invite New” and “Welcome Back” templates) and the goodbye message template to construct the messages sent with the open_service request and close_service request, respectively. The name of the parameter in the form % name % may be replaced with the value provided to construct the message. The parameters and their values may not be stored permanently in the system 202, except in the context of the messages in the conversations where they are employed.

A message may be generated using a parameterized message template 601. The system 202 provides a source of data and algorithm to create a message 606. By way of example, a message template 601 is defined by a provider 205 but based on a default information provided by a brand. The provider 205 may associate the message template 601 with a specific ProviderID which is used by the brand's system to identify the provider 205. This way, the provider 205 can use different templates for different ProviderIDs that may be different local service brands operated by the same provider.

The messages of the provider can be constructed from predefined templates that are editable by and unique to each employee of the provider. A new message template may be used for the first message to a customer new to the provider. The welcome back message template may be used for the first message in a newly opened conversation to an existing customer. The goodbye message template may be used for the last message sent before closing a conversation with a customer. Incoming messages from customers cause notifications in the system.

Calls to the API may be logged for customer support purposes. The following information may be logged: a brand client (the name of the brand using the API), a provider name (the name of the provider), a provider ID (the identifier sent as a parameter to open and close service that maps to the provider that starts or ends the conversation), dispatch API service (the service request (e.g., open_service)), a customer phone number (the mobile phone number of the customer to whom the message is sent), customer first name (the first name of the customer to whom the message is sent), customer last name (the last name of the customer to whom the message is sent), message (the constructed message sent to the customer based on the provider's template), a message delivery status (the delivery status of the message), template variables provided (key-value pairs sent to construct the message and used in the conversation title and label), and so forth.

FIG. 6 shows the operation performed by the collaborative conversation orchestration unit to collaboratively compose a message to be sent, such as a message M-ABC1, in response to an event, such as an event E-ABC1. FIG. 6 shows that the % FIRST_NAME % parameter is drawn from the shared customer record 602 in the data warehouse unit. This first_name may have been provided in an earlier interaction with the customer by a different brand and provider, by a provider in a direct interaction with the customer, or updated by the customer through a customer portal. The service parameters 603 (% DRIVER_ID %, % ETA %, % SERVICE_ADDRESS %, % SERVICE_TYPE %) are provided by the brand in the metadata passed in the open_service request and stored in the data warehouse unit. Furthermore, the % EMPLOYEE_FIRST % parameter 604 is drawn from the provider record in the data warehouse unit and is based on the employee assigned to follow-up on the conversation based on the conditions set by the provider. This way, the collaborative conversation orchestration unit enables the participants in the SDN collaborate on the content of the message 606 that is sent by the communications unit of the system to the customer 206.

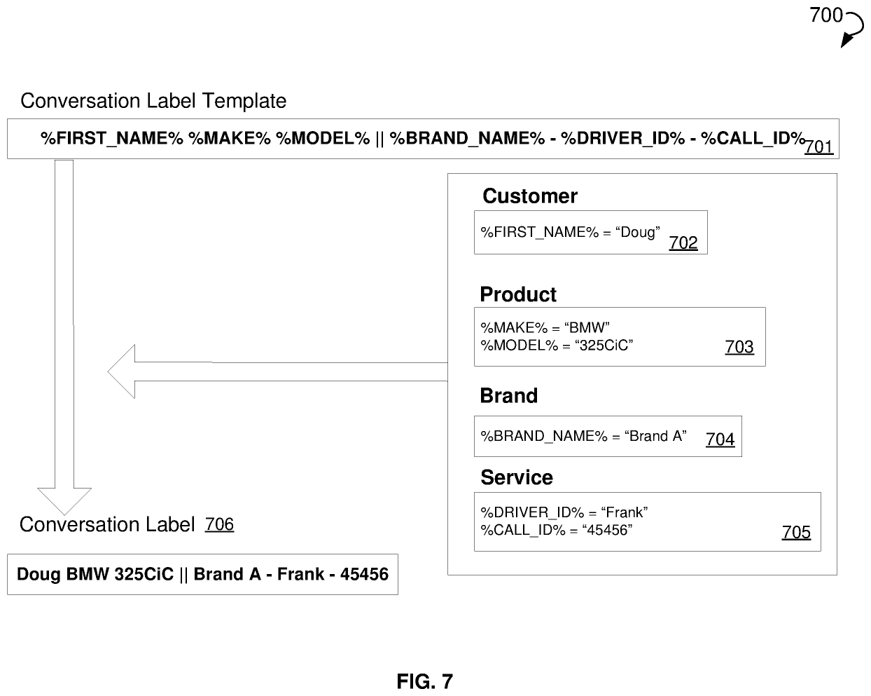

FIG. 7 is a block diagram 700 showing the operation of the collaborative conversation orchestration unit to collaboratively compose a conversation label. The provider may have the ability to edit the conversation label template and the conversation title template. The conversation label template defines the string used to label the conversations in the conversation list. FIG. 7 illustrates synthesizing a conversation label 706 from data associated with the SDN for a conversation initiated in response to an event, such as an event E-ABC1. For a provider managing conversations initiated by multiple brands for multiple customers, the collaborative conversation orchestration unit identifies the conversations accurately. FIG. 7 illustrates an example of forming the conversation label using a parameterized conversation label template 701. The system 202 provides a unique source of the data and algorithms to form the message. By way of example and not limitation, the conversation label template 701 is defined by the provider but based on a default provided by the brand. The provider may associate the conversation label template with a specific ProviderID, which is used by the brand's system to identify the provider. This way, the provider may use different templates for different ProviderIDs that may be different local service brands operated by the same provider.

FIG. 7 shows that the % FIRST_NAME % parameter 702 is drawn from the shared customer record in the data warehouse unit. This first_name may have been provided in an earlier interaction with the customer by a different brand and provider, by a provider in a direct interaction with the customer, or updated by the customer themselves through a customer portal. Furthermore, the product parameter 703 (% MAKE % and % MODEL %) is drawn from the product identified in the service call but owned by the customer. The data may have been provided in an earlier interaction with the customer by a different brand and provider, by a provider in a direct interaction with the customer, or updated by the customer themselves through a customer portal. The % BRAND_NAME % parameter 704 is drawn from the brand record for the brand. The service parameters 705 (% DRIVER_ID %, % CALL_ID %) are provided by the brand in the metadata passed in the open_service request and stored in the data warehouse unit. Using all the above defined parameters, the collaborative conversation orchestration unit enables the data from the SDN to be used to synthesize the conversation labels 706 to help the provider identify the conversation and provide additional context in the conversation portal unit.

The conversation list uses a conversation label 706 defined by a conversation label template. When a conversation is open, the title is defined by the conversation title template. Both the conversation label and the conversation title templates may be unique to each provider and are editable by employees of the provider with the administrator role.

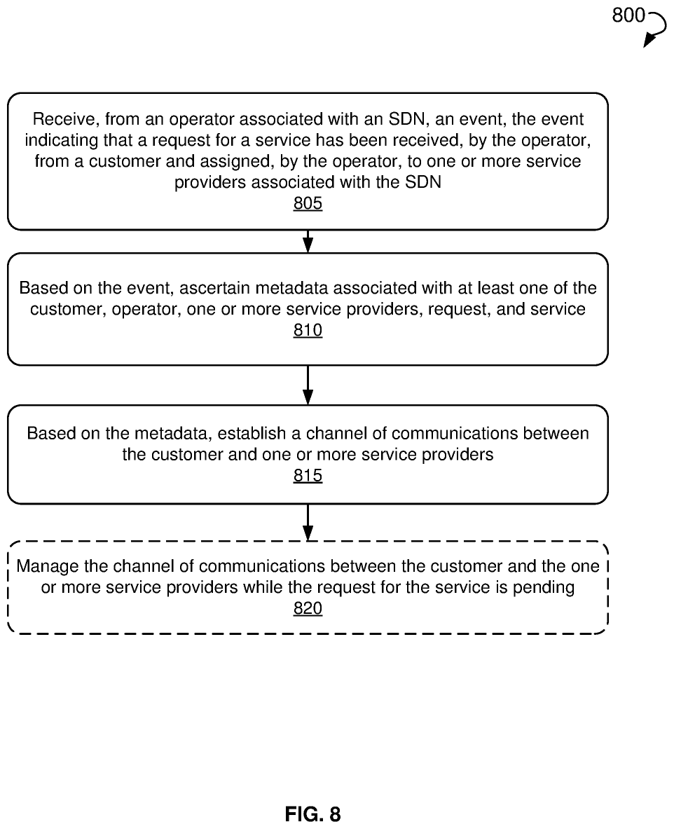

FIG. 8 is a flow chart showing a method 800 for managing communications between customers and service providers within an SDN, according to an example embodiment. The method 800 can be implemented by using the system 202 described above with reference to FIG. 3. For example, the method 800 can be implemented as instructions stored in a memory of a user device which, when executed by the processors of the user device, may cause the user device to perform the operations of the method 800. In some embodiments, the operations of method 800 may be combined, performed in parallel, or performed in a different order. The method 800 may also include additional or fewer operations than those illustrated.

The method 800 may commence in block 805 with receiving an event from an operator associated with the SDN. The event may indicate that a request for a service has been received, by the operator, from a customer and assigned, by the operator, to one or more service providers associated with the SDN. In an example embodiment, the operator associated with the SDN may include a brand enterprise. The one or more service providers may be part of a network of third parties providing services on behalf of the brand enterprise.

The method 800 may continue in block 810 with ascertaining, based on the event, metadata associated with at least one of the customer, the operator, the one or more service providers, the request, and the service. In an example embodiment, the metadata may include at least one of the following: a name of the customer, a phone number of the customer, a location of the customer, pricing information, and so forth.

Based on the metadata, a channel of communications between the customer and the one or more service providers may be established, as shown in block 815. In an example embodiment, the channel of communications is established using a plugin API. The plugin API may be configured to automatically construe messages associated with the communications. The plugin API may be integrated with a CRM system of the operator associated with the SDN. The method 800 may, optionally, continue in block 820 with managing the channel of communications between the customer and the one or more service providers while the request for the service is pending.

In an example embodiment, the establishment of the channel of communications includes providing, via a web application or a mobile application, a user interface to at least one of the one or more service providers and a representative of the operator. In this embodiment, the management of the channel of communications may be at least partially performed by the representative of the operator using the user interface.

In an example embodiment, the establishment of the channel of communications further includes providing a communication initiation message to a user device associated with the customer. The communication initiation message may be provided via a default messaging application running on the user device. In this embodiment, the management of the channel of communications further includes receiving one or more messages from the customer. The one or more messages may be provided by the customer using the default messaging application. The method 800 may include providing the one or more messages to the one or more service providers using the user interface.

In an example embodiment, the management of the channel of communications further includes receiving one or more further messages from the one or more service providers. The one or more further messages may be provided by the one or more service providers using the user interface. The method 800 may include providing the one or more further messages to the user device associated with the customer via the messaging application.

The method 800 may further include receiving, from the one or more service providers, a notification that provisioning of the service in response to the request has been completed. In response to the receipt of the notification, the channel of communications may be closed.

FIG. 9 illustrates an exemplary computing system 900 that can be used to implement embodiments described herein. The computing system 900 can be implemented in the contexts the system 202. The exemplary computing system 900 of FIG. 9 may include one or more processors 910 and memory 920. The memory 920 may store, in part, instructions and data for execution by the one or more processors 910. The memory 920 can store the executable code when the exemplary computing system 900 is in operation. The exemplary computing system 900 of FIG. 9 may further include a mass storage 930, portable storage 940, one or more output devices 950, one or more input devices 960, a network interface 970, and one or more peripheral devices 980.

The components shown in FIG. 9 are depicted as being connected via a single bus 990. The components may be connected through one or more data transport means. The one or more processors 910 and memory 920 may be connected via a local microprocessor bus, and the mass storage 930, one or more peripheral devices 980, portable storage 940, and network interface 970 may be connected via one or more input/output buses.

The mass storage 930, which may be implemented with a magnetic disk drive or an optical disk drive, is a non-volatile storage device for storing data and instructions for use by a magnetic disk or an optical disk drive, which in turn may be used by one or more processors 910. Mass storage 930 can store the system software for implementing embodiments described herein for purposes of loading that software into memory 920.

The portable storage 940 may operate in conjunction with a portable non-volatile storage medium, such as a compact disk (CD) or digital video disc (DVD), to input and output data and code to and from the computing system 900 of FIG. 9. The system software for implementing embodiments described herein may be stored on such a portable medium and input to the computing system 900 via the portable storage 940.

The one or more input devices 960 provide a portion of a user interface. The one or more input devices 960 may include an alphanumeric keypad, such as a keyboard, for inputting alphanumeric and other information, or a pointing device, such as a mouse, a trackball, a stylus, or cursor direction keys. In an example embodiment, the input may be received in the form of voice, which can be sensed and recorded via a virtual assistant application (e.g., Alexa®, Siri®, Google Assistant®) associated with the computing system 900. Additionally, the computing system 900 as shown in FIG. 9 includes one or more output devices 950. Suitable one or more output devices 950 include speakers, printers, network interfaces, and monitors.

The network interface 970 can be utilized to communicate with external devices, external computing devices, servers, and networked systems via one or more communications networks such as one or more wired, wireless, or optical networks including, for example, the Internet, intranet, LAN, WAN, cellular phone networks (e.g., Global System for Mobile communications network, packet switching communications network, circuit switching communications network), Bluetooth® radio, and an IEEE 802.11-based radio frequency network, among others. The network interface 970 may be a network interface card, such as an Ethernet card, optical transceiver, radio frequency transceiver, or any other type of device that can send and receive information. Other examples of such network interfaces may include Bluetooth®, 3G, 4G, 5G, and WiFi® radios in mobile computing devices as well as a Universal Serial Bus.

The one or more peripheral devices 980 may include any type of computer support device to add additional functionality to the computing system. The one or more peripheral devices 980 may include a modem or a router.

The components contained in the exemplary computing system 900 of FIG. 9 are those typically found in computing systems that may be suitable for use with embodiments described herein and are intended to represent a broad category of such computer components that are well known in the art. Thus, the exemplary computing system 900 of FIG. 9 can be a personal computer, handheld computing device, telephone, mobile computing device, workstation, server, minicomputer, mainframe computer, a virtual assistant application (e.g., Alexa®, Siri®, Google Assistant®), or any other computing device. The computer can also include different bus configurations, networked platforms, multi-processor platforms, and so forth. Various operating systems (OS) can be used including UNIX®, Linux®, Windows®, Macintosh® OS, Palm® OS, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the example embodiments. Those skilled in the art are familiar with instructions, processor(s), and storage media.

It is noteworthy that any hardware platform suitable for performing the processing described herein is suitable for use with the example embodiments. The terms “computer-readable storage medium” and “computer-readable storage media” as used herein refer to any medium or media that participate in providing instructions to a central processing unit (CPU) for execution. Such media can take many forms, including, but not limited to, non-volatile media, volatile media, and transmission media. Non-volatile media include, for example, optical or magnetic disks, such as a fixed disk. Volatile media include dynamic memory, such as RAM. Transmission media include coaxial cables, copper wire, and fiber optics, among others, including the wires that include one embodiment of a bus. Transmission media can also take the form of acoustic or light waves, such as those generated during radio frequency and infrared data communications. Common forms of computer-readable media include, for example, a floppy disk, a flexible disk, a hard disk, magnetic tape, any other magnetic medium, a CD-read-only memory (ROM) disk, DVD, any other optical medium, any other physical medium with patterns of marks or holes, a RAM, a PROM, an EPROM, an EEPROM, a FLASHEPROM, any other memory chip or cartridge, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Thus, systems and methods for managing communications between customers and service providers within an SDN have been described. Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

What is claimed is:

1. A system for managing communications between customers and service providers within a service delivery network (SDN), the system comprising:
a processor configured to:
receive, from an operator associated with the SDN, an event indicating that a request for a service has been received, by the operator, from a customer and assigned, by the operator, to one or more service providers associated with the SDN;
based on the event, ascertain metadata associated with at least one of the customer, the operator, the one or more service providers, the request, and the service; and
based on the metadata, establish a channel of communications between the customer and the one or more service providers; and
a memory communicatively coupled to the processor, the memory storing instructions executable by the processor.

2. The system of claim 1, wherein the processor is further configured to manage the channel of communications between the customer and the one or more service providers while the request for the service is pending.

3. The system of claim 1, wherein the operator associated with the SDN includes a brand enterprise, the one or more service providers being part of a network of third parties providing services on behalf of the brand enterprise.

4. The system of claim 1, wherein the metadata includes at least one of the following: a name of the customer, a Short Message Service (SMS) and Multimedia Messaging Service (MMS) enabled phone number of the customer, and wherein the channel of communications includes an SMS/MMS channel of communications.

5. The system of claim 4, wherein the processor is configured to:
require the operator to confirm that the customer has provided an opt-in to allow the operator to communicate via the SMS/MMS channel of communication; and
prompt the operator to extend the opt-in to the service provider solely to address the request for the service.

6. The system of claim 1, wherein the channel of communications is established using a plugin Application Programming Interface (API), the plugin API being configured to automatically construe messages associated with the communications.

7. The system of claim 6, wherein the plugin API is integrated with a Customer Relationship Management (CRM) system or a dispatch system of the operator associated with the SDN.

8. The system of claim 1, wherein the establishment of the channel of communications includes providing, via a web application or a mobile application, a user interface to at least one of the one or more service providers and a representative of the operator.

9. The system of claim 8, wherein the management of the channel of communications is at least partially performed by the representative of the operator using the user interface.

10. The system of claim 8, wherein the establishment of the channel of communications further includes providing a communication initiation message to a user device associated with the customer, the communication initiation message being provided via a default messaging application running on the user device.

11. The system of claim 10, wherein the management of the channel of communications further includes:
receiving one or more messages from the customer, the one or more messages being provided by the customer using the default messaging application; and
providing the one or more messages to the one or more service providers using the user interface.

12. The system of claim 11, wherein the management of the channel of communications includes:
receiving one or more further messages from the one or more service providers, the one or more further messages being provided by the one or more service providers using the user interface; and
providing the one or more further messages to the user device associated with the customer via the default messaging application.

13. The system of claim 1, wherein the processor is further configured to:
receive, from the one or more service providers, a notification that provisioning of the service in response to the request has been competed; and
in response to the receipt of the notification, close the channel of communications.

14. A method for managing communications between customers and service providers within a service delivery network (SDN), the method comprising:
receiving, by a processor, from an operator associated with the SDN, an event indicating that a request for a service has been received, by the operator, from a customer and assigned, by the operator, to one or more service providers associated with the SDN;
based on the event, ascertaining, by the processor, metadata associated with at least one of the customer, the operator, the one or more service providers, the request, and the service; and
based on the metadata, establishing, by the processor, a channel of communications between the customer and the one or more service providers.

15. The method of claim 14, further comprising managing, by the processor, the channel of communications between the customer and the one or more service providers while the request for the service is pending.

16. The method of claim 14, wherein the channel of communications is established using a plugin Application Programming Interface (API), the plugin API being configured to automatically construe messages associated with the communications, wherein the plugin API is integrated with a Customer Relationship Management (CRM) system of the operator associated with the SDN.

17. The method of claim 14, wherein the establishment of the channel of communications includes providing, via a web application or a mobile application, a user interface to at least one of the one or more service providers and a representative of the operator.

18. The method of claim 17, wherein the establishment of the channel of communications further includes providing a communication initiation message to a user device associated with the customer, the communication initiation message being provided via a default messaging application on the user device.

19. The method of claim 18, wherein the management of the channel of communications further includes:
receiving one or more messages from the customer, the one or more messages being provided by the customer using the default messaging application;
providing the one or more messages to the one or more service providers using the user interface;
receiving one or more further messages from the one or more service providers, the one or more further messages being provided by the one or more service providers using the user interface; and
providing the one or more further messages to the user device associated with the customer via the default messaging application.

20. A non-transitory computer-readable storage medium having embodied thereon instructions, which when executed by at least one processor, perform steps of a method comprising:
receive, from an operator associated with a service delivery network (SDN), an event indicating that a request for a service has been assigned by the operator to one or more service providers associated with the SDN in response to receiving the request for the service by the operator from a customer;
based on the event, ascertain metadata associated with at least one of the customer, the operator, the one or more service providers, the request, and the service; and
based on the metadata, establish a channel of communications between the customer and the one or more service providers.
